(19) United States
(12) Patent Application Publication
(10) Pub. No.: US 2022/0405729 A1
(43) Pub. Date: Dec. 22, 2022

(54) INTELLIGENT PAYMENT TERMINAL INSTALLED ON A SHOPPING CART

(71) Applicant: IFREE GROUP(HK)LIMITED, HONG KONG (HK)

(72) Inventors: Wei Hong SOH, Hong Kong (HK); Huihuan SU, Hong Kong (HK); Xiyang GAO, Hong Kong (HK)

(21) Appl. No.: 17/663,625

(22) Filed: May 16, 2022

(30) Foreign Application Priority Data
Jun. 18, 2021 (CN) 202110677897.1

(51) Int. Cl. G06Q 20/20; B62B 5/00

(52) U.S. Cl. CPC G06Q 20/204; G06Q 20/203; B62B 5/00

(57) ABSTRACT

An intelligent payment terminal installed on a shopping cart includes a mounting seat, an mounting assembly adapted to the shopping cart, an information acquisition module for acquiring goods information, a control module for making payment for the goods in the shopping cart, and a power supply module. The mounting assembly is arranged at a lower end of the mounting seat. The information acquisition module is arranged on a side wall of the mounting seat. The control module is arranged on an upper end of the mounting seat. The power supply module is arranged on the mounting seat. The power supply module is electrically connected to the control module. The control module is electrically connected to the information acquisition module. The intelligent payment terminal can be adapted according to the size of the shopping cart and is capable of a payment function.

### CROSS-REFERENCE TO RELATED APPLICATIONS

This application claims the benefit and priority of Chinese patent application No. 202110677897.1, filed on Jun. 18, 2021, disclosure of which is hereby incorporated by reference in its entirety.

### TECHNICAL FIELD

The present application relates to the technical field of shopping cart equipment, and more particularly relates to an intelligent payment terminal installed on a shopping cart.

### BACKGROUND

Nowadays, the mainstream supermarket shopping carts are those used for temporary storage of goods in the traditional sense. In the supermarket scene, the shopping carts serve a single function, and so cannot better serve customers, stores, and product manufacturers. They thus cannot keep up with the trend of development of the current intelligent society.

The existing intelligent shopping carts on the market are basically uniformly customized shopping cart models, which cannot be adapted to different types of shopping carts on the market. The store owner is not able to transform the existing shopping carts, so that the shopping carts in the store may be inconsistent in style and model, thus affecting the storage of the shopping carts.

Therefore, based on the current status of the shopping carts and the premise that they are not intelligent enough, it is very necessary to create a new intelligent terminal installed on the shopping cart.

### SUMMARY

In view of the deficiencies in the related art, the purpose of the present application is to provide an intelligent payment terminal installed on a shopping cart, which can be adapted according to the size of the shopping cart and is capable of a payment function.

The above technical purpose of the present application is achieved through the following technical solutions: an intelligent payment terminal installed on a shopping cart, including: a mounting seat, a mounting assembly adapted to the shopping cart, an information acquisition module for acquiring goods information, a control module for paying for the goods in the shopping cart, and a power supply module. The mounting assembly is arranged at a lower end of the mounting seat. The information acquisition module is arranged on a side wall of the mounting seat. The control module is arranged on an upper end of the mounting seat. The power supply module is arranged on the mounting seat. The power supply module is electrically connected to the control module. The control module is electrically connected with the information acquisition module.

In some embodiments, the mounting assembly includes a locking structure matched with a handrail tube of the shopping cart, and a hook structure matched with a hook rod of the shopping cart. The locking structure is arranged at a lower end of the mounting seat. The hook structure is rotatably arranged on the locking structure.

In some embodiments, the locking structure includes a fixing tube and a movable tube. The fixing tube is arranged on the mounting seat. The movable tube and the fixing tube are detachably connected. A through slot is defined between the fixing tube and the movable tube, and is matched with the handrail tube of the shopping cart.

In some embodiments, a plurality of first elastic bumps are disposed in the fixing tube, and a plurality of second elastic bumps in one-to-one correspondence with the first elastic bumps are disposed in the movable tube.

In some embodiments, the hook structure includes a connecting plate, and an adjusting plate that is connected to the hook rod of the shopping cart. The connecting plate is rotatably arranged on an outer wall of the movable tube. The connecting plate defines a slide slot. The adjusting plate is operative to slide in the slide slot. The adjusting plate defines a waist-shaped hole. A plurality of positioning holes corresponding to the waist-shaped holes are defined in the slide slot. A bolt is provided in the positioning holes. The adjusting plate is fixed to the connecting plate by bolts.

In some embodiments, the adjusting plate is provided with a slot adapted to the hook rod of the shopping cart. An elastic plate for clamping the hook rod is arranged in the slot.

In some embodiments, the power supply module includes: a power supply and a charging unit. The power supply is arranged in the mounting seat. The charging unit is arranged on the mounting seat. The charging unit is electrically connected to the power supply. The power supply is electrically connected to the control module.

In some embodiments, the charging unit includes: a first contact piece assembly and a second contact piece assembly. The first contact piece assembly is arranged at one end of the mounting seat, and the second contact piece assembly is installed at the other end of the mounting seat. The first contact piece assembly is electrically connected to the power supply. The second contact piece assembly is electrically connected to the first contact piece assembly.

In some embodiments, the first contact piece assembly includes a connecting frame, a first conductive contact piece set and several elastic members. The connecting frame is provided with a connecting groove for the mounting seat to slide. The first conductive contact piece set is slidably arranged on the connecting frame and is located at the end of the connecting frame far away from the mounting seat. One end of each elastic member is fixed to the connecting frame, and the other end is fixed to the first conductive contact piece set. The first conductive contact piece set is electrically connected to the power supply. The first conductive contact piece set is electrically connected to the second contact assembly.

In some embodiments, the second contact piece assembly includes a second conductive contact piece set and a magnetic block. The second conductive contact piece set is arranged on the mounting seat and is located at one end thereof away from the first conductive contact piece set. A mounting slot is defined the mounting seat and at the location of the second conductive contact piece set. The magnetic block is arranged in the installation slot.

In view of the above, the present application provides the following beneficial effects:

1. Through the locking structure and the hook structure, the intelligent payment terminal can be adjusted according to the size of the shopping cart, and can be stably installed on the shopping cart.

2. Through the first contact piece assembly and the second contact piece assembly, multiple intelligent payment terminals can be charged at the same time, which facilitates the storage of the shopping cart and the safety of electricity usage in the storage location.

### BRIEF DESCRIPTION OF DRAWINGS

FIG. 1 is a schematic diagram illustrating an installation position of the present application on a shopping cart.

FIG. 2 is a schematic diagram illustrating the overall structure of the present application.

FIG. 3 is a sectional schematic diagram illustrating this application.

FIG. 4 is a circuit block diagram illustrating the present application.

In the drawings: 1. Mounting seat; 2. Mounting assembly; 21. Locking structure; 211. Fixing tube; 212. Movable tube; 213. First elastic bump; 221. Connecting plate; 222. Adjusting plate; 223. Slot; 224. Elastic plate; 3. Information acquisition module; 4. Control module; 5. Power supply module; 51. Power supply; 52. Charging unit; 521. Connecting frame 522. First conductive contact piece set; 523. Elastic member; 524. Second conductive contact piece set; 525. Magnetic block; 6. Through slot; 7. Connecting slot.

### DETAILED DESCRIPTION

In order to make the objects, features and advantages of the present application more clearly understood, the specific embodiments of the present application will be described in detail below with reference to the accompanying drawings. Several embodiments of the present application are presented in the accompanying drawings. However, the present application may be embodied in many different forms and is not to be limited to the embodiments described herein.

As used herein, terms “installed on”, “mounted on”, “connected to”, “coupled to”, “connected with”, “coupled with”, and “fixed to” should be understood in a broad sense unless otherwise specified and defined. For example, they may indicate a fixed connection, a detachable connection, or an integral connection. They may denote a mechanical connection, or an electrical connection. They may denote a direct connection, a connection through an intermediate, or an internal connection between two elements. For those of ordinary skill in the art, the specific meanings of the above terms as used in the present application can be understood depending on specific contexts. Terms “first”, “second”, or the like are merely used for illustrative purposes, and shall not be construed as indicating relative importance or implicitly indicating the number of technical features specified. Thus, unless otherwise specified, the features defined by “first” and “second” may explicitly or implicitly include one or more of such features.

In the present application, unless otherwise expressly specified and defined, a first feature being “on” or “under” a second feature may include the first and second features being in direct contact, or may include the first and second features being not in direct contact but are in contact through another feature disposed therebetween. Furthermore, the first feature being “above”, “over” or “on top of” the second feature includes the first feature being directly above and obliquely above the second feature, or simply means that the first feature is on a higher level than the second feature. The first feature being “below”, “under” or “underneath” the second feature includes the first feature being directly below and diagonally below the second feature, or simply means that the first feature is on a lower level than the second feature. Terms “vertical,” “horizontal,” “left,” “right,” “upper,” “lower,” and similar expressions are for illustration purposes only and do not indicate or imply that the device or element referred to must have a particular orientation, be constructed and operate in a particular orientation, and therefore should not be construed as limiting the present application.

The present application will be described in detail below with reference to the accompanying drawings and embodiments.

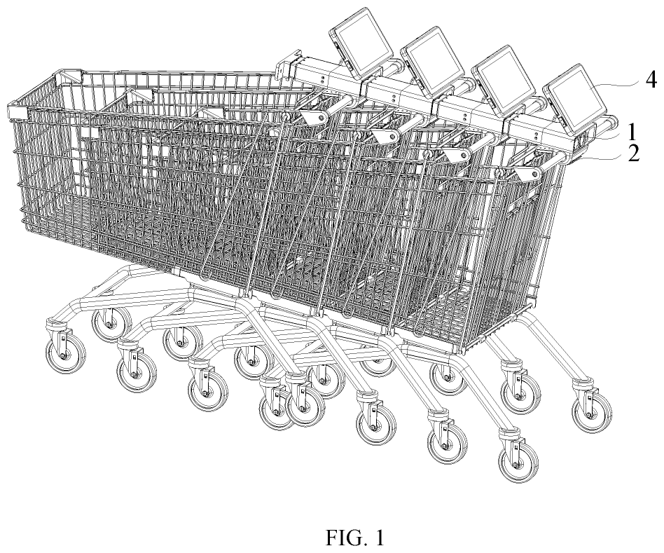

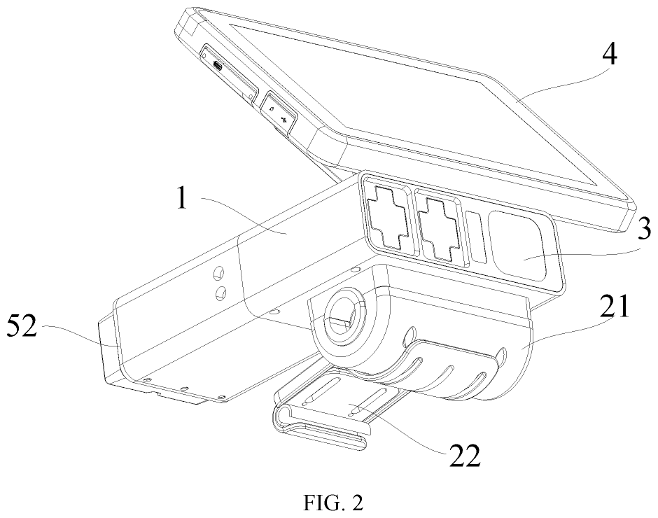

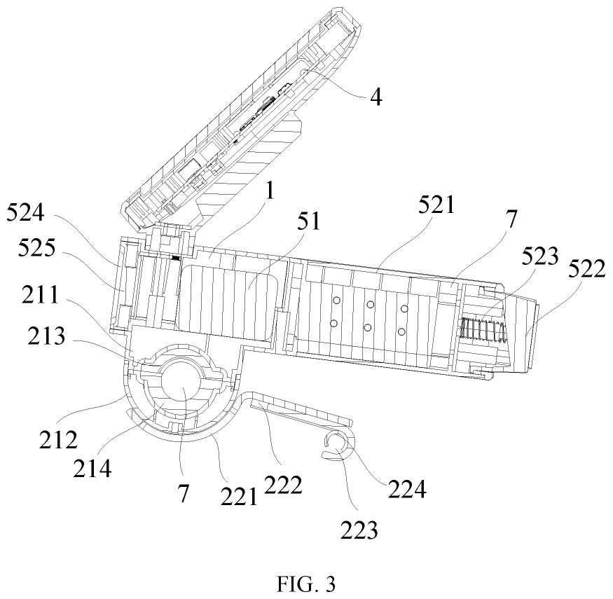

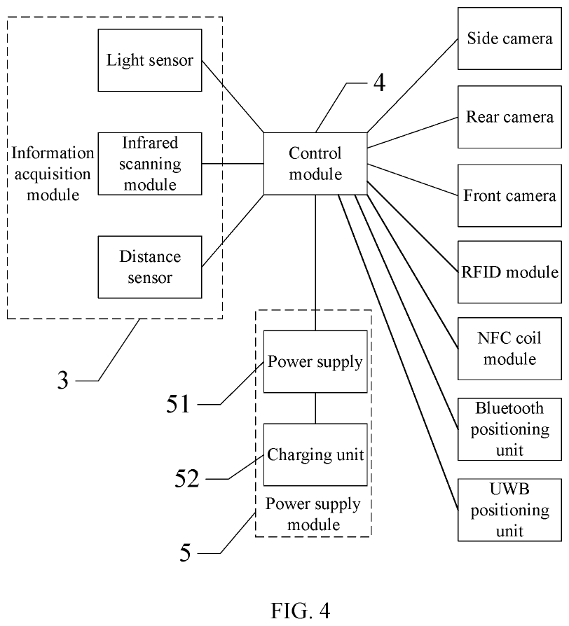

The present application provides an intelligent payment terminal installed on a shopping cart, as shown in FIGS. 1-4, including: an mounting seat 1, an mounting assembly 2 adapted to the shopping cart, and an information acquisition module 3 configured for acquiring goods information, a control module 4 used to pay for the goods in the shopping cart, and a power supply module 5. The mounting assembly 2 is arranged at a lower end of the mounting seat 1. The information acquisition module 3 is arranged on a side wall of the mounting seat 1. The control module 4 is arranged on an upper end of the mounting seat 1. The power supply module 5 is arranged on the mounting seat 1. The power supply module 5 is electrically connected to the control module 4. The control module 4 is electrically connected to the information acquisition module 3.

In practice, the mounting assembly 2 may be adjusted according to the size of the handrail tube and the hook rod of the shopping cart to adapt to the size of the shopping cart, and then the information of the goods can be obtained through the information acquisition module 3 and transmitted to the control module 4, so that the goods can be paid for through the control module 4.

The information acquisition module 3 is implemented as an infrared scanning code module, which can scan and identify a barcode/QR code of a product. A light sensor and a distance sensor are arranged on the mounting seat 1 and next to the information acquisition module 3. The light sensor acquires the ambient light information in front of the information acquisition module 3, and the distance sensor acquires the distance information of an item in front of the information acquisition module 3. Thus, the ON and Off of the information acquisition module 3 is controlled based on the ambient light information and the item distance information, so as to ensure that the item to be scanned is scanned within the set range to prevent misoperation.

The control module 4 may be a control terminal such as a tablet computer or a mobile phone. In this embodiment, a tablet computer adopted, used, and the tablet computer has front and rear cameras, where the front camera may be used for face-swiping payment, and the rear camera may photograph and identify an item in the shopping cart. There is also a side camera on the right side of the screen to identify a shelf. In practice, an angle of inclination between the tablet computer and the horizontal plane is 50°, which on the one hand satisfies adults using the shopping cart tablet, and on the other hand satisfies the rear camera shooting. Both the rear camera and the side camera each use a wide-angle camera with a viewing angle of 115° to meet the needs of the product. The shooting range of the rear camera covers the shopping cart frame. The shooting range of the side camera covers the corresponding height of the shelf. In addition, in order to protect the privacy of customers, a cover that can cover the front camera is set on the tablet computer, where the customer can manually push the cover to protect privacy, or open the cover during checkout for face-swiping payment.

In an optional embodiment, the tablet computer is provided with an RFID module, an NFC coil module and a positioning module. The RFID can interact with a gate in a shopping mall. When passing through the gate, the customer can be allowed to pass through the RFID. The NFC coil module is built into the tablet computer, and can perform read and write operations on a shopping membership card, a discount card, and so on, so as to offer discount or make payment according to the customer's existing card. The positioning module includes a Bluetooth positioning unit and a UWB positioning unit, where the Bluetooth positioning unit and the UWB positioning unit can be used for indoor positioning of equipment. The tablet computer is further provided with a status indicator for indicating a state, and the status indicator emits light of different colors and displays different flashing modes to remind the user of the current state of the tablet computer.

Further, the mounting assembly 2 includes a locking structure 21 matched with the handrail tube of the shopping cart, and a hook structure 22 matched with the hook rod of the shopping cart. The locking structure 21 is arranged on the lower end of the mounting seat 1; the hook structure is rotatably arranged on the locking structure 21.

The mounting seat 1 is fixed to the handrail tube of the shopping cart through the locking structure 21, and then the hook structure 22 is rotated so that the hook structure 22 can be fitted with the hook rod and hooked onto the hook rod, thus securing the mounting seat 1.

In some embodiments, the locking structure 21 includes a fixing tube 211 and a movable tube 212. The fixing tube 211 is arranged on the mounting seat 1. The movable tube 212 is detachably connected to the fixing tube 211. Between the fixing tube 211 and the movable tube 212, a through slot 6 is formed which is adapted to the handrail tube of the shopping cart.

In practice, the fixing tube 211 and the movable tube 212 may both be semicircular tubes, and the fixing tube 211 and the movable tube 212 may be detachably connected by bolts. Therefore, the fixing tube 211 and the movable tube 212 are first separated, then the fixing tube 211 is fitted on the upper outer wall of the handrail tube, and the movable tube 212 is sleeved on the lower outer wall of the handrail tube. Then he fixing tube 211 and the movable tube 212 are fixed by bolts, so that the handrail tube is clamped by the fixing tube 211 and the movable tube 212.

In some embodiments, a plurality of first elastic bumps 213 are provided in the fixing tube 211. The movable tube 212 is provided with a plurality of second elastic bumps 214 in one-to-one correspondence with the first elastic bumps 213. In this embodiment, the first elastic bumps 213 and the second elastic bumps 214 form an elastic convex ring. After the fixing tube 211 and the movable tube 212 are fixed, the first elastic bumps 213 and the second elastic bumps 214 are butted together to form an elastic raised ring, and the inner wall of the elastic raised ring is pressed against the outer wall of the handrail tube, so that the connection of the fixing tube 211 and movable tube 212 with the handrail tube is firmer. In this embodiment, both the first elastic bumps 213 and the second elastic bumps 214 are made of a rubber material.

Further, the hook structure includes a connecting plate 221, and an adjusting plate 222 that is connected to the hook rod of the shopping cart. The connecting plate 221 is rotatably arranged on the outer wall of the movable tube 212. The connecting plate 221 is provided with a slide slot. The adjusting plate 222 can slide in the slide slot. The adjusting plate 222 is provided with a waist-shaped hole. Several positioning holes corresponding to the waist-shaped holes are opened in the slide slot. A bolt is provided in the positioning holes. The adjusting plate 222 is fixed to the connecting plate 221 by the bolt.

In practice, one end of the connecting plate 221 is bent and is attached to the outer wall of the movable tube 212, and through holes are defined here, and a number of screw holes corresponding to the through holes are defined in the movable tube 212, and the connecting plate 221 can be fixed to the movable tube 212 by bolts. In this embodiment, three through holes are opened in the connecting plate 221, and three screw holes corresponding to the three through holes are opened in the movable tube 212, so that the connecting plate 221 can rotate along the outer wall of the movable tube 212. A slide slot is defined at the other end of the connecting plate 221, and the adjusting plate 222 is operative to slide in the slide slot. After the adjusting plate 222 is hung on the hook rod, the adjusting plate 222 is fixed in the slide slot by screws to realize the hanging on the hook rod. The waist-shaped holes allow the adjusting plate 222 to be moved without fully removing the screws and can be fixed in any position. In this embodiment, there are two waist-shaped holes and six positioning holes. Three positioning holes are provided at each waist-shaped hole, and only two positioning holes in the waist-shaped holes are used for positioning and securing. Specifically, after the installation is completed, the center of the handrail tube, the center of the hook rod, and the locking point of the bolt in the positioning hole can form a triangle. By adjusting the installation positions of the connecting plate 221 and the adjusting plate 222, triangles with different side lengths can be formed, so the stability of the installation on the shopping cart can be ensured, and the fixing positions of the bolts can be adjusted to adapt to the tolerances of different handrail tubes and hook rods, and to adjust the horizontal position of the equipment.

Further, the adjusting plate 222 is provided with a groove 223 which is adapted to the hook rod of the shopping cart. An elastic plate 224 for clamping the hook rod is provided in the groove 223. The groove 223 can wrap and fasten the side of the hook rod away from the handrail tube, and the elastic plate 224 can wrap and fasten the other side of the hook rod. When the hooking is performed, the elastic plate 224 is squeezed and deformed by the hooking rod, so that the hooking rod enters between the groove 223 and the elastic plate 224. After the hook rod completely enters the groove 223, the elastic plate 224 rebounds and locks the hook rod in the groove 223 to realize the hooking.

Further, the power supply module 5 includes a power supply 51 and a charging unit 52. The power supply 51 is arranged in the mounting seat 1. The charging unit 52 is arranged on the mounting seat 1. The charging unit 52 is electrically connected to the power supply 51. The power supply 51 is electrically connected to the control module 4. When the shopping cart is not in use, the power supply 51 can be charged by the charging unit 52 to ensure that the power supply 51 has sufficient battery life.

Further, the charging unit 52 includes a first contact piece assembly and a second contact piece assembly. The first contact piece assembly is arranged at one end of the mounting seat 1, and the second contact piece assembly is installed at the other end of the mounting seat 1. The first contact piece assembly is electrically connected to the power supply 51. The second contact piece assembly is electrically connected to the first contact piece assembly.

When the shopping carts are being stored, the latter shopping cart is inserted into the former shopping cart, and the distance between the handrail tubes of the two shopping carts is small, so the first contact piece assembly of the latter shopping cart contacts the second contact piece assembly of the former shopping cart, thereby connecting multiple smart payment terminals on multiple shopping carts in series. Then, a high-power adapter is connected to the first contact piece assembly of the first shopping cart to supply power, so as to supply power to multiple intelligent payment terminals at the same time.

Further, the first contact piece assembly includes a connecting frame 521, a first conductive contact piece set 522, and a plurality of elastic members 523. The connecting frame 521 is provided with a connecting groove 7 for the sliding of the mounting seat 1. The first conductive contact piece set 522 is slidably arranged on the connecting frame 521 and is located at the end thereof away from the mounting seat 1. One end of each elastic member 523 is fixed to the connecting frame 521, and the other end is fixed to the first conductive contact piece set 522. The first conductive contact piece set 522 is electrically connected to the power supply 51. The first conductive contact piece set 522 is electrically connected to the second contact assembly. The elastic member 523 may be a spring.

In practice, the positions of the connecting frame 521 and the mounting seat 1 can also be adjusted according to the size of the shopping cart. The connecting frame 521 is provided with screw holes, and the mounting seat 1 is also provided with several screw holes. In this embodiment, the connecting frame 521 is provided with two screw holes, and the mounting seat 1 is provided with six screw holes, so that there are three installation positions for the installation of the connecting frame 521 and the mounting seat 1. The first conductive contact piece set 522 is slidably arranged on the connecting frame 521, so when they contact the second conductive contact piece set 524 on the previous shopping cart, the elastic members 523 can be deformed, so that the distance between the first conductive contact piece set 522 and the second contact piece assembly on the previous shopping cart is matched.

Further, the second contact piece assembly includes a second conductive contact piece set 524 and a magnetic block 525. The second conductive contact piece set 524 is disposed on the mounting seat 1 and is located at an end thereof away from the first conductive contact piece set 522. A mounting slot is opened in the mounting seat 1 and at the location of the second conductive contact piece set 524. The magnetic block 525 is arranged in the installation slot. The first conductive contact piece set 522 and the second conductive contact piece set 524 both have conductive contacts, and the conductive contacts can be attracted by magnets. By arranging the magnet, the connection stability of the second conductive contact piece set 524 and the first conductive contact piece set 522 can be ensured when in contact with the first conductive contact piece set 522 on the next shopping cart.

Because the larger the number of series connected devices to be charged, the greater the current that passes through, and the contact piece assembly is provided with a magnet structure, if encountering a conductive material that can be adsorbed by the magnet, a short circuit as well as sparks may occur. Therefore, a separation structure is provided in the middle of the first conductive contact piece set 522 and the second conductive contact piece set 524 to ensure that the object attracted by the magnet does not contact the two contact pieces at the same time. In combination with the charging circuit which prohibits reverse power supply and which has short circuit protection, the safety of the device during charging can be ensured.

The intelligent payment terminal installed on a shopping cart of the present application can be adapted according to the size of the shopping cart and has a payment function.

The above are only the preferred embodiments of the present application, and the protection scope of the present application is not limited to the above-mentioned embodiments, and all technical solutions under the idea of the present application belong to the protection scope of the present application. It should be pointed out that for those skilled in the art, some improvements and modifications without departing from the principle of the present application should also be regarded as falling in the protection scope of the present application.

What is claimed is:

1. An intelligent payment terminal installed on a shopping cart, comprising a mounting seat, an mounting assembly adapted to the shopping cart, an information acquisition module configured for acquiring goods information, a control module configured for making a payment for goods in the shopping cart, and a power supply module; wherein the mounting assembly is arranged at a lower end of the mounting seat; wherein the information acquisition module is arranged on a side wall of the mounting seat; wherein the control module is arranged on an upper end of the mounting seat; wherein the power supply module is arranged on the mounting seat; wherein the power supply module is electrically connected to the control module; wherein the control module is electrically connected to the information acquisition module.

2. The intelligent payment terminal as recited in claim 1, wherein the mounting assembly comprises a locking structure matched with a handrail tube of the shopping cart, and a hook structure matched with a hook rod of the shopping cart; wherein the locking structure is arranged at a lower end of the mounting seat; wherein the hook structure is rotatably arranged on the locking structure.

3. The intelligent payment terminal as recited in claim 2, wherein the locking structure comprises a fixing tube and a movable tube; wherein the fixing tube is arranged on the mounting seat; wherein the movable tube is detachably connected to the fixing tube; wherein a through slot is defined between the fixing tube and the movable tube and is matched with the handrail tube of the shopping cart.

4. The intelligent payment terminal as recited in claim 3, wherein a plurality of first elastic bumps are arranged in the fixing tube; wherein a plurality of second elastic bumps in one-to-one correspondence with the first elastic bumps are arranged in the movable tube.

5. The intelligent payment terminal as recited in claim 3, wherein the hook structure comprises a connecting plate, and an adjusting plate hooked with the hook rod of the shopping cart; wherein the connecting plate is rotatably arranged on an outer wall of the movable tube; wherein the connecting plate defines a slide slot; wherein the adjusting plate is operative to slide in the slide slot; wherein the adjusting plate comprises a waist-shaped hole; wherein a plurality of positioning holes corresponding to the waist-shaped holes are defined in the slide slot; wherein bolts are arranged in the positioning holes; wherein the adjusting plate is fixed to the connecting plate by the bolts.

6. The intelligent payment terminal as recited in claim 5, wherein the adjusting plate comprises a groove adapted to the hook rod of the shopping cart; wherein an elastic plate is arranged in the groove and configured for clamping the hook rod.

7. The intelligent payment terminal as recited in claim 1, wherein the power supply module comprises a power supply and a charging unit; wherein the power supply is arranged in the mounting seat; wherein the charging unit is arranged on the mounting seat; wherein the charging unit is electrically connected to the power supply; wherein the power supply is electrically connected to the control module.

8. The intelligent payment terminal as recited in claim 7, wherein the charging unit comprises a first contact piece assembly and a second contact piece assembly; wherein the first contact piece assembly is arranged at one end of the mounting seat, and the second contact piece assembly is installed at another end of the mounting seat; wherein the first contact piece assembly is electrically connected to the power supply; wherein the second contact piece assembly is electrically connected to the first contact piece assembly.

9. The intelligent payment terminal as recited in claim 8, wherein the first contact piece assembly comprises a connecting frame, a first conductive contact piece set and a plurality of elastic members; wherein the connecting frame comprises a connecting groove configured for the mounting seat to slide therein; wherein the first conductive contact piece set is slidably arranged on the connecting frame and is located at an end of the connecting frame away from the mounting seat; wherein one end of each of the plurality of elastic members is fixed to the connecting frame, and another end thereof is fixed to the first conductive contact piece set; wherein the first conductive contact piece set is electrically connected to the power supply; wherein the first conductive contact piece set is electrically connected to the second contact assembly.

10. The intelligent payment terminal as recited in claim 9, wherein the second contact piece assembly comprises a second conductive contact piece set and a magnetic block; wherein the second conductive contact piece set is arranged on the mounting seat and is disposed at an end of the mounting seat away from the first conductive contact piece set; wherein a mounting groove is defined in the mounting seat and at the location of the second conductive contact piece set; wherein the magnetic block is arranged in the mounting groove; wherein the second conductive contact piece set is electrically connected to the first conductive contact piece set.
